(19) United States
(12) Patent Application Publication
(10) Pub. No.: US 2023/0061281 A1
(43) Pub. Date: Mar. 2, 2023

(54) COOLING SYSTEM

(71) Applicant: TOYOTA JIDOSHA KABUSHIKI KAISHA, Toyota-shi Aichi-ken (JP)

(72) Inventor: Takayuki Shimauchi, Toyota-shi Aichi-ken (JP)

(73) Assignee: TOYOTA JIDOSHA KABUSHIKI KAISHA, Toyota-shi Aichi-ken (JP)

(21) Appl. No.: 17/885,954

(22) Filed: Aug. 11, 2022

(30) Foreign Application Priority Data
Sep. 2, 2021 (JP) 2021-143010

(51) Int. Cl. B60H 1/32; B60H 1/00

(52) U.S. Cl. CPC B60H 1/323; B60H 1/00; B60H 1/00278; B60H 1/00878

(57) ABSTRACT

A ratio between a flow rate of a refrigerant flowing in an air conditioning heat exchanger of an air conditioner of which a blowout port mode is a face mode and a flow rate of a refrigerant flowing in a battery cooling heat exchanger is determined based on a battery temperature. As a result, depending on the battery temperature, air conditioning can be prioritized over battery cooling, and comfort of an occupant can be ensured. On the other hand, the flow rate of the refrigerant flowing in the battery cooling heat exchanger is larger than the flow rate of the refrigerant flowing in the air conditioning heat exchanger of the air conditioner of which the blowout port mode is a mode other than the face mode. As a result, the battery cooling can be prioritized and deterioration of a battery can be suppressed.

### CROSS-REFERENCE TO RELATED APPLICATION

This application claims priority to Japanese Patent Application No. 2021-143010 filed on Sep. 2, 2021, incorporated herein by reference in its entirety.

### BACKGROUND

### 1. Technical Field

The present disclosure relates to a vehicle cooling system that air-conditions a vehicle cabin and cools a battery mounted on a vehicle.

### 2. Description of Related Art

Japanese Unexamined Patent Application Publication No. 2019-182135 (JP 2019-182135 A) discloses a cooling system including a freezing cycle in which a refrigerant flows in a compressor, an air conditioning heat exchanger, and a battery cooling heat exchanger. In a technique disclosed in JP 2019-182135 A, when an occupant is on board or when air conditioning is requested, the flow rate of the refrigerant flowing in the air conditioning heat exchanger is increased as compared with the flow rate of the refrigerant flowing in the battery cooling heat exchanger, and the air conditioning capacity is prioritized over the battery cooling capacity. Further, when the battery coolant temperature is higher than a threshold value regardless of the presence or absence of the occupant or the presence or absence of the air conditioning request, the flow rate of the refrigerant flowing in the air conditioning heat exchanger is reduced as compared with the flow rate of the refrigerant flowing in the battery cooling heat exchanger, and the battery cooling capacity is prioritized over the air conditioning capacity.

However, in the technique disclosed in JP 2019-182135 A, the ratio between the flow rate of the refrigerant flowing in the air conditioning heat exchanger and the flow rate of the refrigerant flowing in the battery cooling heat exchanger is not changed, and it is not determined whether the air conditioning capacity or the battery cooling capacity is prioritized, depending on whether an air conditioner blowout port mode is a face (FACE) mode, which greatly contributes to comfort of the occupant, or the other cases. Therefore, there is room for improvement in ensuring the comfort of the occupant and suppressing deterioration of the battery due to cooling of the battery.

### SUMMARY

An object of the present disclosure is to provide a cooling system capable of ensuring comfort of an occupant and suppressing deterioration of a battery.

The present disclosure that achieves the above object is as follows.

(1) A cooling system includes a freezing cycle in which a refrigerant flows in a compressor, an air conditioning heat exchanger provided in at least one air conditioner, and a battery cooling heat exchanger for cooling a battery.
In an air conditioner of the at least one air conditioner of which a blowout port mode is a face mode, a ratio between a flow rate of a refrigerant flowing in the air conditioning heat exchanger provided in the air conditioner in the face mode and a flow rate of a refrigerant flowing in the battery cooling heat exchanger is determined based on a temperature of the battery.
In an air conditioner of the at least one air conditioner of which the blowout port mode is a mode other than the face mode, the flow rate of the refrigerant flowing in the battery cooling heat exchanger is larger than the flow rate of the refrigerant flowing in the air conditioning heat exchanger provided in the air conditioner in the mode other than the face mode.
(2) According to the cooling system described in (1), the at least one air conditioner includes two air conditioners, a front air conditioner and a rear air conditioner.
(3) According to the cooling system described in (1) or (2), in the freezing cycle, a battery side expansion valve that is able to adjust the flow rate of the refrigerant flowing in the battery cooling heat exchanger is provided on an upstream side of the battery cooling heat exchanger in a refrigerant flow direction.
The flow rate of the refrigerant flowing in the battery cooling heat exchanger is adjusted when an opening degree of the battery side expansion valve is adjusted.
When all the blowout port modes are a mode other than the face mode in the at least one air conditioner, the opening degree of the battery side expansion valve is constant.

The blowout port modes of the air conditioner include a face (FACE) mode that blows out air conditioning air toward an upper body of an occupant, a foot (FOOT) mode that blows out the air conditioning air toward a foot of the occupant, and a bi-level (BI-LEVEL) mode that blows out the air conditioning air toward the upper body and the foot of the occupant. Of these modes, the face (FACE) mode is a mode in which the air conditioning air is blown out toward the upper body of the occupant, so that the contribution to comfort of the occupant is relatively large among the blowout port modes.

Based on this, with the cooling system according to (1), the ratio of the flow rate of the refrigerant flowing in the air conditioning heat exchanger provided in the air conditioner in the face mode and the flow rate of the refrigerant flowing in the battery cooling heat exchanger is determined based on the battery temperature, so that depending on the battery temperature, the flow rate of the refrigerant flowing in the air conditioning heat exchanger provided in the air conditioner in the face mode can be increased as compared with the flow rate of the refrigerant flowing in the battery cooling heat exchanger. Specifically, when the battery temperature is relatively low and the urgency of the battery cooling is low, the flow rate of the refrigerant flowing in the battery cooling heat exchanger is relatively small, so that the flow rate of the refrigerant flowing in the air conditioning heat exchanger provided in the air conditioner in the face mode can be increased as compared with the flow rate of the refrigerant flowing in the battery cooling heat exchanger. As a result, depending on the battery temperature, air conditioning can be prioritized over battery cooling, and the comfort of the occupant can be ensured.

On the other hand, since the flow rate of the refrigerant flowing in the battery cooling heat exchanger is larger than the flow rate of the refrigerant flowing in the air conditioning heat exchanger provided in the air conditioner in a mode other than the face mode, the battery cooling can be prioritized as compared with a case where the flow rate of the refrigerant flowing in the air conditioning heat exchanger is increased as compared with the flow rate of the refrigerant flowing in the battery cooling heat exchanger in the air conditioner in the mode other than the face mode, so that deterioration of the battery can be suppressed. Therefore, it is possible to ensure the comfort of the occupant when the blowout port mode is the face mode, which greatly contributes to the comfort of the occupant, while the deterioration of the battery is suppressed.

With the cooling system according to (2), the at least one air conditioner includes two air conditioners, the front air conditioner and the rear air conditioner. Therefore, even when the air conditioner includes the front air conditioner and the rear air conditioner, the air conditioning of the air conditioner in the face mode can be prioritized over the battery cooling depending on the battery temperature, so that the comfort of the occupant is ensured.

With the cooling system according to (3), when all the blowout port modes are the mode other than the face mode in the at least one air conditioner, the opening degree of the battery side expansion valve is constant, so that control of the battery side expansion valve becomes simpler than when the opening degree of the battery side expansion valve is not constant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a cooling system according to an embodiment of the present disclosure;

FIG. 2 is a block diagram of a control device of the cooling system according to the embodiment of the present disclosure;

FIG. 3 is a diagram showing a relationship between a target blowout temperature and a blowout port mode of the control device of the cooling system according to the embodiment of the present disclosure during automatic air conditioning;

FIG. 4 is a control matrix of the control device of the cooling system according to the embodiment of the present disclosure;

FIG. 5 is a graph showing a relationship between air conditioning capacity and a battery temperature in the cooling system according to the embodiment of the present disclosure; and

FIG. 6 is a graph showing a relationship between battery cooling capacity and a battery temperature in the cooling system according to the embodiment of the present disclosure.

### DETAILED DESCRIPTION OF EMBODIMENTS

Hereinafter, a cooling system 10 according to an embodiment of the present disclosure will be described with reference to the drawings.

A vehicle on which the cooling system 10 is mounted is an electrified vehicle, and is a plug-in hybrid electric vehicle (PHEV) capable of obtaining a travel driving force of the vehicle from a motor powered by a battery and an internal combustion engine (engine). However, the vehicle may be an electrified vehicle such as a battery electric vehicle (BEV), a hybrid electric vehicle (HEV), or a fuel cell electric vehicle (FCEV).

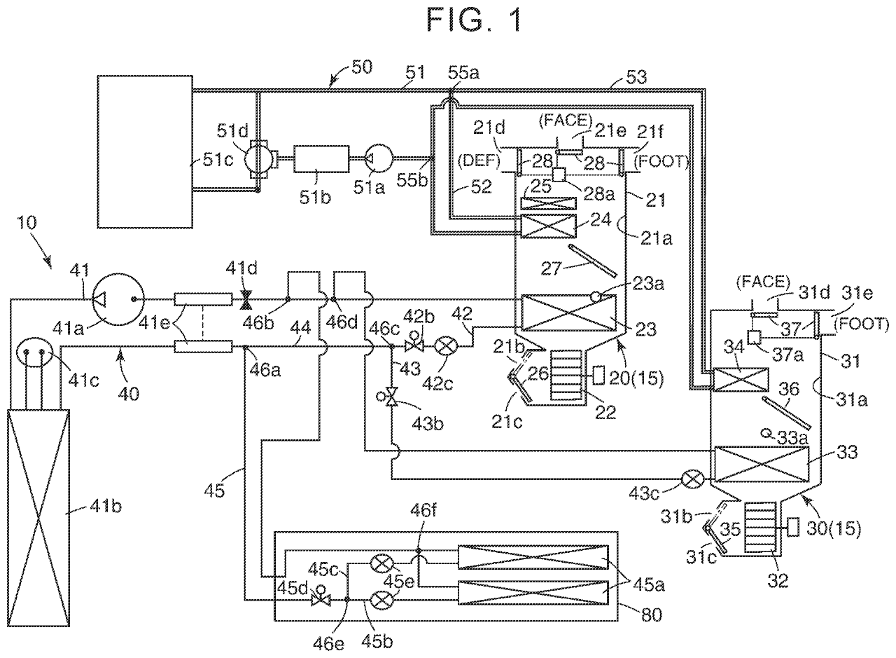

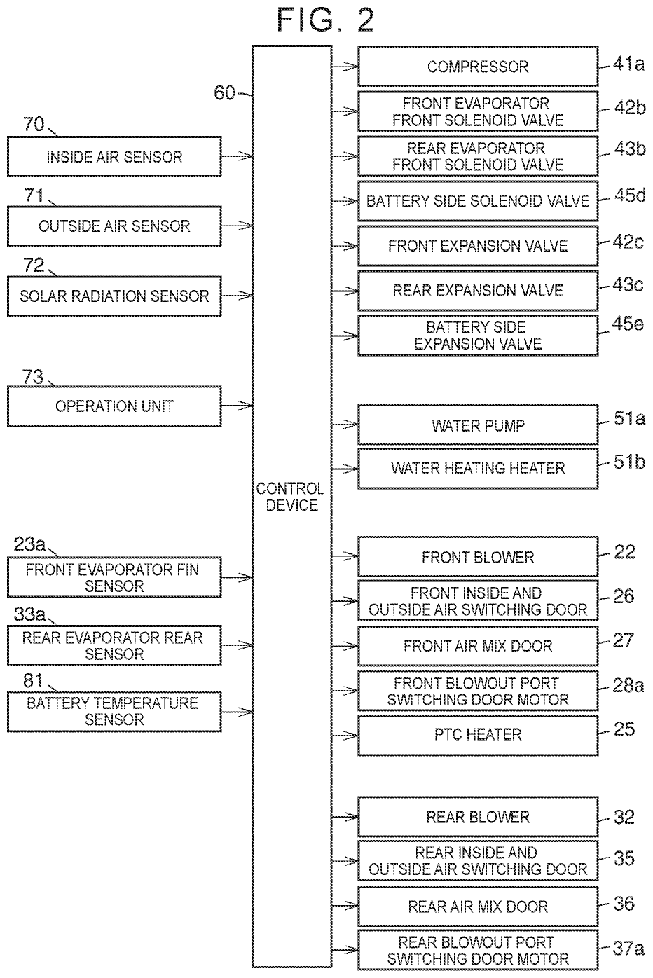

As shown in FIGS. 1 and 2, the cooling system 10 includes an air conditioner 15, a freezing cycle 40, a coolant circuit 50, and a control device 60. In the present disclosure, the front and the rear may be referred to as Fr and Rr, respectively.

As shown in FIG. 1, at least one air conditioner 15 is provided, and in the embodiment and a shown example of the present disclosure, two air conditioners, which are a front air conditioner 20 and a rear air conditioner 30, are provided.

The front air conditioner 20 may be referred to as a front air conditioner or a front indoor air conditioner unit (front-heating ventilation and air conditioning (Fr-HVAC)). The front air conditioner 20 is provided, for example, inside an instrument panel of a vehicle, and mainly air-conditions an area of a front seat in a vehicle cabin. The front air conditioner 20 includes a front air conditioning duct 21, a front blower 22, a front air conditioning heat exchanger (front evaporator) 23, a front heater core 24, a positive temperature coefficient (PTC) heater 25, a front inside and outside air switching door 26, a front air mix door 27, and a front blowout port switching door 28.

The front air conditioning duct 21 includes therein, a ventilation path 21a through which air conditioning air for air-conditioning the vehicle cabin flows. The front air conditioning duct 21 includes an outside air suction port 21b that takes in the air outside the vehicle (outside air) into the ventilation path 21a and an inside air suction port 21c that takes in the air inside the vehicle cabin (inside air) into the ventilation path 21a at the upstream end in the air flow direction. The front air conditioning duct 21 includes a plurality of blowout ports 21d, 21e, and 21f for blowing out the air of the ventilation path 21a into the vehicle cabin at the downstream end in the air flow direction.

The front outside air suction port 21b and the front inside air suction port 21c can be opened and closed by the front inside and outside air switching door 26. When the front inside and outside air switching door 26 closes the front inside air suction port 21c (in the outside air introduction mode), the front outside air suction port 21b is opened and the air is taken into the ventilation path 21a from the front outside air suction port 21b. When the front inside and outside air switching door 26 closes the front outside air suction port 21b (in the inside air introduction mode), the front inside air suction port 21c is opened and the air is taken into the ventilation path 21a from the front inside air suction port 21c.

The blowout port 21d is a defroster (DEF) blowout port that blows out the air toward a windshield, the blowout port 21e is a face (FACE) blowout port that blows out the air toward the upper body including the head of an occupant, and the blowout port 21f is a foot (FOOT) blowout port that blows the air toward the foot of the occupant.

The front blowout port switching door 28 is provided on each of the blowout ports 21d, 21e, and 21f. Each front blowout port switching door 28 is driven by a front blowout port switching door motor 28a. With the front blowout port switching door 28, a front blowout port mode that is a blowout port mode of the air conditioning air blown out toward the vehicle cabin can be changed to any one of the defroster (DEF) mode, the face (FACE) mode, a bi-level (BI-LEVEL) mode, the foot (FOOT) mode, and a foot defroster (FOOT-DEF) mode.

The front blower 22 is disposed in the front air conditioning duct 21 on the downstream side in the air flow direction of the front inside and outside air switching door 26. The front blower 22 generates an air flow in the ventilation path 21a. With an operation amount of the front blower 22, it is possible to adjust an air amount (wind amount) that flows in the ventilation path 21a.

The front air conditioning heat exchanger 23 is disposed in the front air conditioning duct 21 on the downstream side in the air flow direction of the front blower 22. The front air conditioning heat exchanger 23 removes (cools) heat from the air in the ventilation path 21a by exchanging the heat between the refrigerant flowing therein and the air in the ventilation path 21a. A front evaporator fin sensor 23a capable of detecting the temperature of the front air conditioning heat exchanger 23 is attached to the front air conditioning heat exchanger 23.

The front heater core 24 is disposed in the front air conditioning duct 21 on the downstream side in the air flow direction of the front air conditioning heat exchanger 23. The front heater core 24 applies heat (heats) to the air in the ventilation path 21a by exchanging the heat between the coolant flowing therein and the air in the ventilation path 21a.

The PTC heater 25 is disposed in the front air conditioning duct 21 on the downstream side in the air flow direction of the front heater core 24. The PTC heater 25 is an electric heater as an auxiliary heater for heating the air that has passed through the front heater core 24.

The front air mix door 27 is disposed in the front air conditioning duct 21 on the downstream side in the air flow direction of the front air conditioning heat exchanger 23 and on the upstream side in the air flow direction of the front heater core 24 A ratio between the air amount (wind amount) flowing in the front heater core 24 and PTC heater 25 and the air amount (wind amount) that bypasses the front heater core 24 and the PTC heater 25, of the air that has passed through the front air conditioning heat exchanger 23, can be changed by the front air mix door 27.

The rear air conditioner 30 may be referred to as a rear air conditioner or a rear air conditioner unit (Rr-HVAC). The rear air conditioner 30 mainly air-conditions an area of a rear seat in the vehicle cabin. The rear air conditioner 30 includes a rear air conditioning duct 31, a rear blower 32, a rear air conditioning heat exchanger (rear evaporator) 33, a rear heater core 34, a rear inside and outside air switching door 35, a rear air mix door 36, and a rear blowout port switching door 37.

The rear air conditioning duct 31 includes therein, a ventilation path 31a through which air conditioning air for air-conditioning the vehicle cabin flows. The rear air conditioning duct 31 includes an outside air suction port 31b that takes in the air outside the vehicle (outside air) into the ventilation path 31a and an inside air suction port 31c that takes in the air inside the vehicle cabin (inside air) into the ventilation path 31a at the upstream end in the air flow direction. The rear air conditioning duct 31 includes a plurality of blowout ports 31d and 31e for blowing out the air of the ventilation path 31a into the vehicle cabin at the downstream end in the air flow direction.

The outside air suction port 31b and the inside air suction port 31c can be open and closed by the rear inside and outside air switching door 35. When the rear inside and outside air switching door 35 closes the inside air suction port 31c (in the outside air introduction mode), the outside air suction port 31b is opened and the air is taken into the ventilation path 31a from the outside air suction port 31b. When the rear inside and outside air switching door 35 closes the outside air suction port 31b (in the inside air introduction mode), the inside air suction port 31c is opened and the air is taken into the ventilation path 31a from the inside air suction port 31c.

The blowout port 31d is a face (FACE) blowout port that blows out the air toward the upper body including the head of the occupant, and the blowout port 31e is a foot (FOOT) blowout port that blows out the air toward the foot of the occupant.

The rear blowout port switching door 37 is provided on each of the blowout ports 31d and 31e. Each rear blowout port switching door 37 is driven by a rear blowout port switching door motor 37a. With the rear blowout port switching door 37, a rear blowout port mode that is a blowout port mode of the air conditioning air blown out toward the vehicle cabin can be changed to any one of the face (FACE) mode, the bi-level (BI-LEVEL) mode, and the foot (FOOT) mode.

The rear blower 32 is disposed in the rear air conditioning duct 31 on the downstream side in the air flow direction of the rear inside and outside air switching door 35. The rear blower 32 generates an air flow in the ventilation path 31a. With an operation amount of the rear blower 32, it is possible to adjust an air amount (wind amount) that flows in the ventilation path 31a.

The rear air conditioning heat exchanger 33 is disposed in the rear air conditioning duct 31 on the downstream side in the air flow direction of the rear blower 32. The rear air conditioning heat exchanger 33 removes (cools) heat from the air in the ventilation path 31a by exchanging the heat between the refrigerant flowing therein and the air in the ventilation path 31a. A rear evaporator rear sensor 33a capable of detecting the temperature of the air flowing in the rear air conditioning heat exchanger 33 is provided on the downstream side of the rear air conditioning heat exchanger 33.

The rear heater core 34 is disposed in the rear air conditioning duct 31 on the downstream side in the air flow direction of the rear air conditioning heat exchanger 33. The rear heater core 34 applies heat (heats) to the air in the ventilation path 31a by exchanging the heat between the coolant flowing therein and the air in the ventilation path 31a.

The rear air mix door 36 is disposed in the rear air conditioning duct 31 on the downstream side in the air flow direction of the rear air conditioning heat exchanger 33 and on the upstream side in the air flow direction of the rear heater core 34. A ratio between the air amount (wind amount) flowing in the rear heater core 34 and the air amount (wind amount) that bypasses the rear heater core 34, of the air that has passed through the rear air conditioning heat exchanger 33, can be changed by the rear air mix door 36.

In the front air conditioning heat exchanger 23 and the rear air conditioning heat exchanger 33, the refrigerant flowing therein can be circulated by the freezing cycle 40. The freezing cycle 40 includes a common flow path 41, an air conditioning side flow path 44 including a front side air conditioning flow path 42 and a rear side air conditioning flow path 43, and a battery cooling side flow path 45, as a refrigerant flow path through which the refrigerant flows.

A compressor 41a, a condenser 41b, and a receiver 41c are disposed in the common flow path 41. The compressor 41a compresses and discharges the refrigerant circulating in the freezing cycle 40. The condenser 41b exchanges heat between the refrigerant discharged from the compressor 41a and the air outside the vehicle cabin to cool the refrigerant. The receiver 41c is connected to the downstream side of the condenser 41b, separates the air and the liquid of the refrigerant condensed by the condenser 41b, and stores the liquid refrigerant. Only one compressor 41a, one condenser 41b, and one receiver 41c are provided in the freezing cycle 40.

Further, an evaporation pressure adjusting valve 41d and a double tube type internal heat exchanger 41e are disposed in the common flow path 41. The evaporation pressure adjusting valve 41d is disposed on the upstream side of the compressor 41a. The double tube type internal heat exchanger 41e exchanges heat between the refrigerant flowing on the downstream side of the evaporation pressure adjusting valve 41d and on the upstream side of the compressor 41a and the refrigerant flowing on the downstream side of the condenser 41b and the receiver 41c.

The air conditioning side flow path 44 is a portion located on the downstream side of a first branch portion 46a located on the downstream side of the condenser 41b and the receiver 41c, and is a portion located on the upstream side of a first merging portion 46b located on the upstream side of the compressor 41a.

The front side air conditioning flow path 42 is a portion located on the downstream side of a second branch portion 46c located on the downstream side of the first branch portion 46a, and is a portion located on the upstream side of a second merging portion 46d located on the upstream side of the first merging portion 46b. The front air conditioning heat exchanger 23 is disposed in the front side air conditioning flow path 42.

In the front side air conditioning flow path 42, a front evaporator front solenoid valve 42b and a front expansion valve 42c are further disposed on the upstream side of the front air conditioning heat exchanger 23. The front evaporator front solenoid valve 42b turns on and off the refrigerant flow from the common flow path 41 to the front side air conditioning flow path 42. The front expansion valve 42c reduces the pressure of the refrigerant that has passed through the front evaporator front solenoid valve 42b. Further, the front expansion valve 42c adjusts the flow rate of the refrigerant flowing in the front air conditioning heat exchanger 23 by adjusting the opening degree thereof. The front expansion valve 42c is an electric expansion valve. The front evaporator front solenoid valve 42b may be disposed on the downstream side of the second branch portion 46c as shown in FIG. 1 and on the upstream side of the second branch portion 46c although not shown in FIG. 1, as long as the front evaporator front solenoid valve 42b is disposed on the downstream side of the first branch portion 46a.

The refrigerant flowing in the common flow path 41 passes through the front evaporator front solenoid valve 42b, the pressure thereof is reduced by the front expansion valve 42c, and the flow rate thereof is adjusted. Then, the refrigerant flows in the front air conditioning heat exchanger 23. In the front air conditioning heat exchanger 23, the refrigerant takes heat from the surrounding air, and the air around the front air conditioning heat exchanger 23 is cooled.

The rear side air conditioning flow path 43 is parallel to the front side air conditioning flow path 42 between the second branch portion 46c and the second merging portion 46d. The rear air conditioning heat exchanger 33 is disposed in the rear side air conditioning flow path 43.

In the rear side air conditioning flow path 43, a rear evaporator front solenoid valve 43b and a rear expansion valve 43c are further disposed on the upstream side of the rear air conditioning heat exchanger 33. The rear evaporator front solenoid valve 43b turns on and off the refrigerant flow from the common flow path 41 to the rear side air conditioning flow path 43. The rear expansion valve 43c reduces the pressure of the refrigerant that has passed through the rear evaporator front solenoid valve 43b. Further, the rear expansion valve 43c adjusts the flow rate of the refrigerant flowing in the rear air conditioning heat exchanger 33 by adjusting the opening degree thereof. The rear expansion valve 43c may be a mechanical expansion valve or an electric expansion valve.

The refrigerant flowing in the common flow path 41 passes through the rear evaporator front solenoid valve 43b, the pressure thereof is reduced by the rear expansion valve 43c, and the flow rate thereof is adjusted. Then, the refrigerant flows in the rear air conditioning heat exchanger 33. In the rear air conditioning heat exchanger 33, the refrigerant takes heat from the surrounding air, and the air around the rear air conditioning heat exchanger 33 is cooled.

The battery cooling side flow path 45 is a refrigerant flow path for cooling the battery when the temperature of the battery (not shown) housed in a battery pack 80 rises. A battery temperature sensor 81 (see FIG. 2) capable of detecting the battery temperature is attached to the battery. The battery cooling side flow path 45 is parallel to the air conditioning side flow path 44 between the first branch portion 46a and the first merging portion 46b.

Battery cooling heat exchangers 45a are disposed in the battery cooling side flow path 45. The battery cooling heat exchangers 45a are disposed in the battery pack 80 together with the battery. The battery cooling side flow path 45 includes first and second battery side parallel flow path portions 45b and 45c that are parallel to each other between a battery side branch portion 46e and a battery side merging portion 46f provided in the battery cooling side flow path 45. Then, the battery cooling heat exchanger 45a is disposed in each of the first and second battery side parallel flow path portions 45b and 45c.

Further, in the battery cooling side flow path 45, a battery side solenoid valve 45d and a battery side expansion valves 45e are disposed on the upstream side of the battery cooling heat exchangers 45a. The battery side solenoid valve 45d is disposed on the upstream side of the battery side branch portion 46e, and turns on and off the refrigerant flow from the common flow path 41 to the battery cooling side flow path 45. The battery side expansion valve 45e is disposed in each of the first and second battery side parallel flow path portions 45b and 45c, and reduces the pressure of the refrigerant passing through the battery side solenoid valve 45d. Further, the battery side expansion valve 45e adjusts the flow rate of the refrigerant flowing in the battery cooling heat exchanger 45a by adjusting the opening degree thereof. The battery side expansion valve 45e may be a mechanical expansion valve, but is an electric expansion valve.

The refrigerant flowing in the common flow path 41 passes through the battery side solenoid valve 45d, the pressure thereof is reduced by the battery side expansion valve 45e, and the flow rate thereof is adjusted. Then, the refrigerant flows in the battery cooling heat exchanger 45a. In the battery cooling heat exchanger 45a, the refrigerant takes heat from the surrounding air, and the air around the battery cooling heat exchanger 45a is cooled.

The front expansion valve 42c, the rear expansion valve 43c, and the battery side expansion valve 45e each adjust the opening degree to adjust the flow rate of the refrigerant. Therefore, the opening ratio of each of the front expansion valve 42c, the rear expansion valve 43c, and the battery side expansion valve 45e is adjusted, so that it is possible to adjust the ratio of the flow rate of the refrigerant flowing in each the front side air conditioning flow path 42, the rear side air conditioning flow path 43, and the battery cooling side flow path 45.

In the front heater core 24 and the rear heater core 34, the coolant flowing therein can be circulated by the coolant circuit 50. The coolant circuit 50 includes a coolant common portion 51 in which a water pump 51a, a water heating heater 51b, an internal combustion engine (engine) 51c, and a three-way valve 51d are disposed, and front and rear coolant parallel portions 52 and 53 that are parallel to each other between a coolant branch portion 55a and a coolant merging portion 55b.

The water pump 51a compresses and discharges the coolant flowing in the coolant circuit 50. The water heating heater 51b raises the temperature of the coolant by the electric power of the battery. The three-way valve 51d switches a route of the coolant that flows in the coolant common portion 51 between a flow of the coolant that passes through the internal combustion engine 51c and a flow of the coolant that does not pass through the internal combustion engine 51c.

The front heater core 24 is disposed in the front coolant parallel portion 52, and the rear heater core 34 is disposed in the rear coolant parallel portion 53. The coolant that has flowed from the coolant common portion 51 through the coolant branch portion 55a to the front coolant parallel portion 52 flows to the front heater core 24. The front heater core 24 applies heat to the surrounding air by exchanging the heat between the coolant and the surrounding air. The coolant that has flowed from the coolant common portion 51 through the coolant branch portion 55a to the rear coolant parallel portion 53 flows to the rear heater core 34. The rear heater core 34 applies heat to the surrounding air by exchanging the heat between the coolant and the surrounding air.

The control device 60 can control the front air conditioner 20, the rear air conditioner 30, the freezing cycle 40, and the coolant circuit 50.

As shown in FIG. 2, the front evaporator fin sensor 23a, the rear evaporator rear sensor 33a, the battery temperature sensor 81, an inside air sensor 70 for detecting the vehicle cabin temperature, an outside air sensor 71 for detecting the vehicle outside temperature, and a solar radiation sensor 72 for detecting the solar radiation amount are connected to the input side of the control device 60. The inside air sensor 70 and the solar radiation sensor 72 are provided on each of the front air conditioner 20 and the rear air conditioner 30. Further, an operation unit 73 for the occupant of the vehicle to perform operations such as turning on and off the front air conditioner 20 and the rear air conditioner 30 and setting the air conditioning temperature is connected to the control device 60.

The compressor 41a, the front evaporator front solenoid valve 42b, the rear evaporator front solenoid valve 43b, the battery side solenoid valve 45d, the front expansion valve 42c, the rear expansion valve 43c, the battery side expansion valve 45e, the water pump 51a, the water heating heater 51b, the front blower 22, the front inside and outside air switching door 26, the front air mix door 27, the front blowout port switching door motor 28a, the PTC heater 25, the rear blower 32, the rear inside and outside air switching door 35, the rear air mix door 36, the rear blowout port switching door motor 37a, and the like are connected to the output side of the control device 60.

When the control device 60 operates (turns on) the front air conditioner 20 by flowing the refrigerant in the front air conditioning heat exchanger 23, the control device 60 turns on the compressor 41a, opens the front evaporator front solenoid valve 42b to allow the refrigerant to flow in the front air conditioning heat exchanger 23, and controls the opening degree of the front expansion valve 42c. Further, the control device 60 turns on the front blower 22.

When the control device 60 operates (turns on) the rear air conditioner 30 by flowing the refrigerant in the rear air conditioning heat exchanger 33, the control device 60 turns on the compressor 41a, opens the rear evaporator front solenoid valve 43b to allow the refrigerant to flow in the rear air conditioning heat exchanger 33, and controls the opening degree of the rear expansion valve 43c. Further, the control device 60 turns on the rear blower 32.

When the control device 60 flows the refrigerant in the battery cooling heat exchanger 45a, the control device 60 turns on the compressor 41a, opens the battery side solenoid valve 45d to allow the refrigerant to flow in the battery cooling heat exchanger 45a, and controls the opening degree of the battery side expansion valve 45e.

The control device 60 calculates a target blowout temperature (TAO) that is a target temperature of the air conditioning air blown out from the air conditioning duct 21 and/or the air conditioning duct 31 in the air conditioner that is operated (turned on), when the front air conditioner 20 and/or the rear air conditioner 30 are/is operated (turned on). The control device 60 calculates the TAO using the following formula (1).

TAO=Kset×Tset−Kr×Tr−Kam×Tam−Ks×Ts+C (1)

Tset is a set temperature set by the occupant. Tr is a vehicle cabin temperature detected by the inside air sensor 70. Tam is an outside air temperature detected by the outside air sensor 71. Ts is the solar radiation amount detected by the solar radiation sensor 72. Further, Kset, Kr, Kam, and Ks are gains, and C is a correction constant.

When the automatic air conditioning is turned on by the occupant, the control device 60 automatically controls the front and rear air mix doors 27 and 36, controls on/off operations of the compressor 41a, and controls the front and rear blowout port switching door motors 28a and 37a depending on the target blowout temperature (TAO). However, the control of the front and rear blowout port switching door motors 28a and 37a and the like can be manually performed by the occupant even when the automatic air conditioning is turned off.

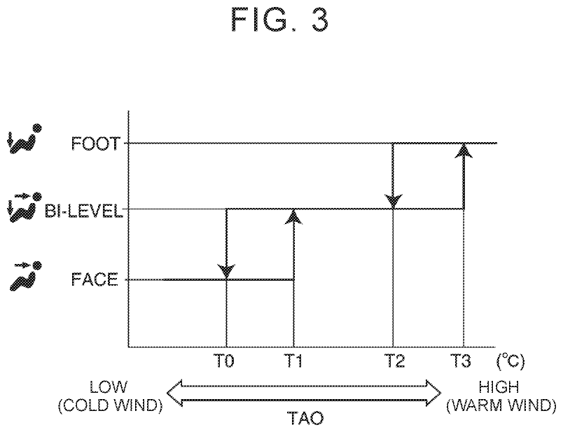

FIG. 3 shows a relationship between the target blowout temperature (TAO) and the front blowout port mode acquired by drive control of the front blowout port switching door motor 28a, when the automatic air conditioning is turned on in the front air conditioner 20. FIG. 3 can also be applied to a relationship between the target blowout temperature (TAO) and the rear blowout port mode acquired by drive control of the rear blowout port switching door motor 37a, when the automatic air conditioning is turned on in the rear air conditioner 30.

In a case where the target blowout temperature (TAO) is rising, when TAO TO is satisfied, the blowout port mode is the face (FACE) mode, and when the TAO rises and reaches T1 (>T0), the blowout port mode switches from the face (FACE) mode to the bi-level (BI-LEVEL) mode. When the TAO further rises and reaches T3 (>T1), the blowout port mode switches from the bi-level (BI-LEVEL) mode to the foot (FOOT) mode.

In contrast, in a case where the TAO is decreasing, when the TAO decreases from when TAO≥T3 is satisfied to when the TAO reaches T2 (T1<T2<T3), the blowout port mode switches from the foot (FOOT) mode to the bi-level (BI-LEVEL) mode. Further, when the TAO further decreases and reaches T0 (<T1), the blowout port mode switches from the bi-level (BI-LEVEL) mode to the face (FACE) mode.

When the TAO is rising and when the TAO is decreasing, there is a difference of T1−T0 in the switching temperature between the face (FACE) mode and the bi-level (BI-LEVEL) mode, and there is a difference of T3−T2 in the switching temperature between the bi-level (BI-LEVEL) mode and the foot (FOOT) mode. These are hysteresis widths for suppressing control hunting.

Here, the battery tends to deteriorate at a high temperature. Therefore, when the battery temperature rises and it becomes necessary to cool the battery (when a battery cooling request is made), the control device 60 turns on the compressor 41a and opens the battery side solenoid valve 45d to allow the refrigerant to flow in the battery cooling heat exchanger 45a. However, in a case where the battery cooling request is made when the refrigerant is flown in at least one of the air conditioning heat exchangers 23 and 33 and at least one of the front and rear air conditioners 20 and 30 is operated, the flow rate of the refrigerant flown in the air conditioning heat exchanger 23 or 33 of the air conditioner 20 or 30 in operation decreases if the battery side solenoid valve 45d is opened and a part of the refrigerant is flown in the battery cooling heat exchanger 45a. As a result, the cooling capacity of the air in the air conditioning heat exchanger 23 or 33 decreases, which may deteriorate the air conditioning comfort of the occupant.

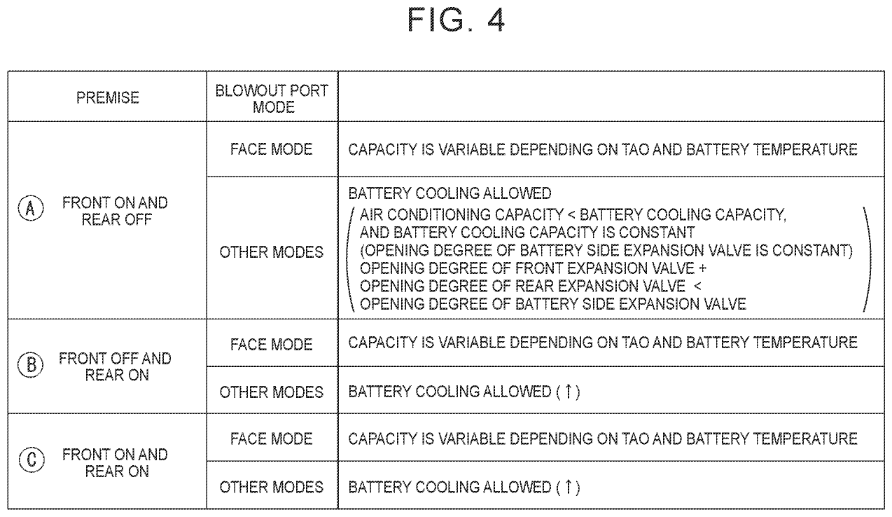

The risk of deteriorating the air conditioning comfort is generally small and negligible when the room temperature is stable after the air has been cooled down, as compared with a case in which the air is cooling down. However, even when the room temperature is stable after the air has been cooled down, the contribution to the comfort of the occupant is greater when the blowout port mode is the face mode than when the blowout port mode is the other modes, so that the risk of deteriorating the air conditioning comfort may not be negligible. Therefore, the control device 60 can execute the control matrix shown in FIG. 4 when the room temperature is stable after the air has been cooled down.

Whether the room temperature is stable after the air has been cooled down is determined by whether there is a difference between the blowout temperature used under the actual environment and the target blowout temperature determined from the TAO in the air conditioner 20 or 30 in operation when at least one of the front air conditioner 20 and the rear air conditioner 30 is operating, or whether a predetermined time has elapsed after both the front and rear air conditioners 20 and 30 are turned on and the battery cooling request is made when both the air conditioners 20 and 30 are operating and the battery cooling request is made. The “blowout temperature used under the actual environment” is substantially equal to the temperature of the air conditioning heat exchanger 23 or 33 in the air conditioner 20 or 30 in operation during the cooling operation, or the temperature of the downstream side of the air conditioning heat exchanger 23 or 33. Therefore, in the front air conditioner 20, the temperature is detected by the front evaporator fin sensor 23a, and in the rear air conditioner 30, the temperature is detected by the rear evaporator rear sensor 33a. Further, the “predetermined time” is set to become shorter as the battery temperature becomes higher.

FIG. 4 shows the control matrix of the control device 60 when an air conditioner in operation of the front air conditioner 20 and the rear air conditioner 30 is in a stable room temperature state and a battery cooling request is made. The control matrix shown in FIG. 4 has premises A, B, and C.

Premise A

The battery cooling request is made, and the front air conditioner 20 is operating but the rear air conditioner 30 is not operating.

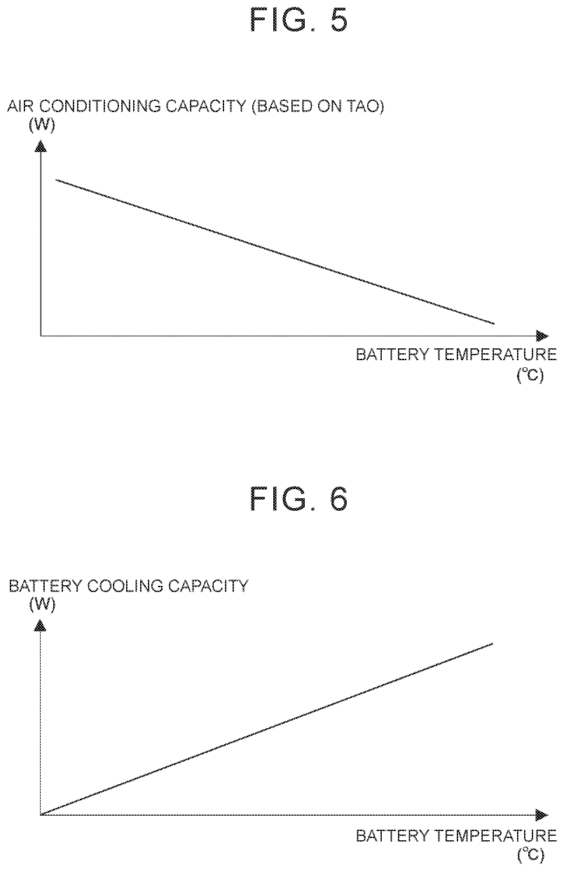

(A-1) In the above premise A, when the front blowout port mode is the face mode, the opening degrees of the front expansion valve 42c and the battery side expansion valve (refers to each battery side expansion valve although two battery side expansion valves 45e are provided in the shown example of the present disclosure) 45e are adjusted, so that the ratio of the flow rate of the refrigerant flowing in each of the front air conditioning heat exchanger 23 and the battery cooling heat exchanger 45a is determined based on the battery temperature for when the battery cooling request is made. Specifically, (i) as shown in FIG. 5, the opening degree of the front expansion valve 42c is increased as the battery temperature is low, so that the flow rate of the refrigerant flowing in the front air conditioning heat exchanger 23 is increased to increase the air conditioning capacity of the front air conditioner 20. On the other hand, (ii) as shown in FIG. 6, the opening degree of the battery side expansion valve 45e is reduced as the battery temperature is low, so that the flow rate of the refrigerant flowing in the battery cooling heat exchanger 45a is reduced to reduce the battery cooling capacity.

(A-2) In the above premise A, when the front blowout port mode is a mode other than the face mode, the front expansion valve 42c remains to be controlled based on the TAO of the front air conditioner 20, and the battery cooling side is prioritized over the front air conditioner 20. Specifically, the opening degree of the battery side expansion valve (refers to each battery side expansion valve although two battery side expansion valves 45e are provided in the shown example of the present disclosure) 45e is set to a predetermined opening degree α larger than the opening degree of the front expansion valve 42c. The predetermined opening degree α is constant regardless of whether the front air conditioner 20 and/or the rear air conditioner 30 are/is operating. Further, the predetermined opening degree α is larger than the sum of the opening degrees of the front expansion valve 42c and the rear expansion valve 43c when both the front air conditioner 20 and the rear air conditioner 30 are operating in a mode other than the face mode and both the front expansion valve 42c and the rear expansion valve 43c are open.

Premise B

The battery cooling request is made, and the rear air conditioner 30 is operating but the front air conditioner 20 is not operating.

(B-1) In the above premise B, when the rear blowout port mode is the face mode, the opening degrees of the rear expansion valve 43c and the battery side expansion valve (refers to each battery side expansion valve although two battery side expansion valves 45e are provided in the shown example of the present disclosure) 45e are adjusted, so that the ratio of the flow rate of the refrigerant flowing in each of the rear air conditioning heat exchanger 33 and the battery cooling heat exchanger 45a is determined based on the battery temperature for when the battery cooling request is made. Specifically, as in the above (A-1), (i) as shown in FIG. 5, the opening degree of the rear expansion valve 43c is increased as the battery temperature is low, so that the flow rate of the refrigerant flowing in the rear air conditioning heat exchanger 33 is increased to increase the air conditioning capacity of the rear air conditioner 30. On the other hand, (ii) as shown in FIG. 6, the opening degree of the battery side expansion valve 45e is reduced as the battery temperature is low, so that the flow rate of the refrigerant flowing in the battery cooling heat exchanger 45a is reduced to reduce the battery cooling capacity.

(B-2) In the above premise B, when the rear blowout port mode is a mode other than the face mode, the rear expansion valve 43c remains to be controlled based on the TAO of the rear air conditioner 30, and the battery cooling side is prioritized over the rear air conditioner 30. Specifically, the opening degree of the battery side expansion valve (refers to each battery side expansion valve although two battery side expansion valves 45e are provided in the shown example of the present disclosure) 45e is set to a predetermined opening degree α larger than the opening degree of the rear expansion valve 43c.

Premise C

The battery cooling request is made, and both the front air conditioner 20 and the rear air conditioner 30 are operating.

(C-1) In the above premise C, when only the front blowout port mode is the face mode and the rear blowout port mode is a mode other than the face mode, the rear expansion valve 43c remains to be controlled based on the TAO of the rear air conditioner 30. While a state in which the opening degree of the battery side expansion valve (refers to each battery side expansion valve although two battery side expansion valves 45e are provided in the shown example of the present disclosure) 45e is larger than the opening degree of the rear expansion valve 43c is maintained, the front expansion valve 42c and the battery side expansion valve 45e are subjected to the same control as in the above (A-1).

(C-2) In the above premise C, when only the rear blowout port mode is the face mode and the front blowout port mode is a mode other than the face mode, the front expansion valve 42c remains to be controlled based on the TAO of the front air conditioner 20. While a state in which the opening degree of the battery side expansion valve (refers to each battery side expansion valve although two battery side expansion valves 45e are provided in the shown example of the present disclosure) 45e is larger than the opening degree of the front expansion valve 42c is maintained, the rear expansion valve 43c and the battery side expansion valve 45e are subjected to the same control as in the above (B-1).

(C-3) In the above premise C, when both the front blowout port mode and the rear blowout port mode are the face mode, the opening degrees of the front expansion valve 42c, the rear expansion valve 43c, and the battery side expansion valve (refers to each battery side expansion valve although two battery side expansion valves 45e are provided in the shown example of the present disclosure) 45e are adjusted, so that the ratio of the flow rate of the refrigerant flowing in each of the front air conditioning heat exchanger 23, the rear air conditioning heat exchanger 33, and the battery cooling heat exchanger 45a is determined based on the battery temperature for when the battery cooling request is made. Specifically, (i) as shown in FIG. 5, the opening degrees of the front expansion valve 42c and the rear expansion valve 43c are increased as the battery temperature is low, so that the flow rate of the refrigerant flowing in each of the front air conditioning heat exchanger 23 and the rear air conditioning heat exchanger 33 is increased to increase the air conditioning capacity of each of the front air conditioner 20 and the rear air conditioner 30. On the other hand, (ii) as shown in FIG. 6, the opening degree of the battery side expansion valve 45e is reduced as the battery temperature is low, so that the flow rate of the refrigerant flowing in the battery cooling heat exchanger 45a is reduced to reduce the battery cooling capacity.

(C-4) In the above premise C, when both the front blowout port mode and the rear blowout port mode are modes other than the face mode, the front expansion valve 42c remains to be controlled based on the TAO of the front air conditioner 20, the rear expansion valve 43c remains to be controlled based on the TAO of the rear air conditioner 30, and the battery cooling side is prioritized over the front air conditioner 20 and the rear air conditioner 30. Specifically, the opening degree of the battery side expansion valve (refers to each battery side expansion valve although two battery side expansion valves 45e are provided in the shown example of the present disclosure) 45e is set to a predetermined opening degree α larger than the sum of the opening degrees of the front expansion valve 42c and the rear expansion valve 43c.

When the battery cooling request is made, and both the front air conditioner 20 and the rear air conditioner 30 are not operating, the opening degree of the battery side expansion valve (refers to each battery side expansion valve although two battery side expansion valves 45e are provided in the shown example of the present disclosure) 45e is set to a predetermined opening degree α.

Next, operations and effects of the embodiment of the present disclosure will be described.

The blowout port modes of the front air conditioner 20 and the rear air conditioner 30 include the face (FACE) mode that blows out the air conditioning air toward the upper body of the occupant, the foot (FOOT) mode that blows out the air conditioning air toward the foot of the occupant, and the bi-level (BI-LEVEL) mode that blows out the air conditioning air toward the upper body and foot of the occupant. Of these modes, the face (FACE) mode is a mode in which the air conditioning air is blown out toward the upper body of the occupant, so that the contribution to the comfort of the occupant is relatively large among the blowout port modes.

Based on this, (I) in the embodiment of the present disclosure, the ratio of the flow rate of the refrigerant flowing in the air conditioning heat exchanger provided in the air conditioner in the face mode and the flow rate of the refrigerant flowing in the battery cooling heat exchanger 45a is determined based on the battery temperature, so that depending on the battery temperature, the flow rate of the refrigerant flowing in the air conditioning heat exchanger provided in the air conditioner in the face mode can be increased as compared with the flow rate of the refrigerant flowing in the battery cooling heat exchanger 45a. Specifically, when the battery temperature is relatively low and the urgency of the battery cooling is low, the flow rate of the refrigerant flowing in the battery cooling heat exchanger 45a is relatively small, so that the flow rate of the refrigerant flowing in the air conditioning heat exchanger provided in the air conditioner in the face mode can be increased as compared with the flow rate of the refrigerant flowing in the battery cooling heat exchanger 45a. As a result, depending on the battery temperature, the air conditioning can be prioritized over the battery cooling, and the comfort of the occupant can be ensured.

On the other hand, since the flow rate of the refrigerant flowing in the battery cooling heat exchanger 45a is larger than the flow rate of the refrigerant flowing in the air conditioning heat exchanger provided in the air conditioner in a mode other than the face mode, the battery cooling can be prioritized as compared with a case where the flow rate of the refrigerant flowing in the air conditioning heat exchanger is increased as compared with the flow rate of the refrigerant flowing in the battery cooling heat exchanger 45a in the air conditioner in the mode other than the face mode, so that deterioration of the battery can be suppressed. Therefore, it is possible to ensure the comfort of the occupant when the blowout port mode is the face mode, which greatly contributes to the comfort of the occupant, while the deterioration of the battery is suppressed.

(II) There are two air conditioners 15, the front air conditioner 20 and the rear air conditioner 30. Therefore, even when the air conditioner 15 includes the front air conditioner 20 and the rear air conditioner 30, the air conditioning of the air conditioner in the face mode can be prioritized over the battery cooling depending on the battery temperature, so that the comfort of the occupant is ensured.

(III) When the blowout port modes of both the front air conditioner 20 and the rear air conditioner 30 are modes other than the face mode, the opening degree of the battery side expansion valve 45e is set to the constant opening degree α, so that the control of the battery side expansion valve 45e becomes simpler than when the opening degree of the battery side expansion valve 45e is not constant.

(IV) When the blowout port modes of both the front air conditioner 20 and the rear air conditioner 30 are modes other than the face mode, the battery cooling is prioritized over the air conditioning of the front air conditioner 20 and the rear air conditioner 30, so that the deterioration of the battery can be suppressed. Therefore, the present disclosure is advantageous in terms of improving the cruising range by the battery, and is also advantageous in terms of suppressing deterioration of the quietness of the vehicle.

What is claimed is:

1. A cooling system comprising a freezing cycle in which a refrigerant flows in a compressor, an air conditioning heat exchanger provided in at least one air conditioner, and a battery cooling heat exchanger for cooling a battery, wherein:
in an air conditioner of the at least one air conditioner of which a blowout port mode is a face mode, a ratio between a flow rate of a refrigerant flowing in the air conditioning heat exchanger provided in the air conditioner in the face mode and a flow rate of a refrigerant flowing in the battery cooling heat exchanger is determined based on a temperature of the battery; and
in an air conditioner of the at least one air conditioner of which the blowout port mode is a mode other than the face mode, the flow rate of the refrigerant flowing in the battery cooling heat exchanger is larger than the flow rate of the refrigerant flowing in the air conditioning heat exchanger provided in the air conditioner in the mode other than the face mode.

2. The cooling system according to claim 1, wherein the at least one air conditioner includes two air conditioners, a front air conditioner and a rear air conditioner.

3. The cooling system according to claim 1, wherein:
in the freezing cycle, a battery side expansion valve that is able to adjust the flow rate of the refrigerant flowing in the battery cooling heat exchanger is provided on an upstream side of the battery cooling heat exchanger in a refrigerant flow direction;
the flow rate of the refrigerant flowing in the battery cooling heat exchanger is adjusted when an opening degree of the battery side expansion valve is adjusted; and
when all the blowout port modes are a mode other than the face mode in the at least one air conditioner, the opening degree of the battery side expansion valve is constant.
